(19) United States
(12) Patent Application Publication
(10) Pub. No.: US 2026/0239130 A1
(43) Pub. Date: Aug. 13, 2026

(54) METHODS AND APPARATUSES FOR A CONDITION-BASED CELL SWITCHING PROCEDURE

(71) Applicant: Lenovo (Beijing), Beijing (CN)

(72) Inventors: Lianhai Wu, Beijing (CN); Mingzeng Dai, Shanghai (CN); Prateek Basu Mallick, Dreieich (DE); Joachim Löhr, Wiesbaden (DE); Congchi Zhang, Shanghai (CN)

(73) Assignee: Lenovo (Beijing) Limited, Beijing (CN)

(21) Appl. No.: 19/156,705

(22) PCT Filed: Feb. 16, 2023
(86) PCT No.: PCT/CN2023/076526

§ 371 Date: Aug. 14, 2025

(51) Int. Cl. H04W 36/00; H04W 56/00; H04W 74/0833

(52) U.S. Cl. CPC H04W 36/0077; H04W 56/0045; H04W 74/0833

(57) ABSTRACT

Embodiments of the present application relate to methods and apparatuses for a condition-based cell switching procedure under a 3rd Generation Partnership Project (3GPP) 5G system or the like. According to an embodiment of the present application, a user equipment (UE) includes a transceiver and a processor coupled to the transceiver, and the processor is configured to: receive radio resource control (RRC) configuration information associated with one or more candidate cells via the transceiver from a source cell; and transmit an RRC configuration complete message via the transceiver in response to accessing one candidate cell within the one or more candidate cells based on the RRC configuration information. In some embodiments of the present application, accessing one candidate cell may be triggered by a lower layer signaling.

### TECHNICAL FIELD

Embodiments of the present application generally relate to wireless communication technology, especially to methods and apparatuses for a condition-based cell switching procedure.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g. time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Currently, details regarding a condition-based cell switching procedure have not been discussed in 3GPP 5G technology yet.

### SUMMARY

Some embodiments of the present application provide a user equipment (UE). The UE includes a transceiver and a processor coupled to the transceiver; and the processor is configured to: receive radio resource control (RRC) configuration information associated with one or more candidate cells via the transceiver from a source cell; and transmit an RRC configuration complete message via the transceiver in response to accessing one candidate cell within the one or more candidate cells based on the RRC configuration information.

In some embodiments, the processor of the UE is configured to receive a set of execution conditions regarding the one or more candidate cells via the transceiver from the source cell, and wherein the set of execution conditions is generated by a centralized unit (CU) of a base station (BS) or by a source distributed units (DU) of the BS associated with the source cell.

In some embodiments, the processor of the UE is configured to receive configuration information regarding at least one of a first timer or a second timer, wherein the first timer is configured to be used when a timing advance (TA) value associated with the one or more candidate cells is unavailable at the UE, and wherein the second timer is configured to be used when the TA value is available at the UE.

In some embodiments, the processor of the UE is configured to start to evaluate an execution condition within the set of execution conditions upon the reception of the RRC configuration information.

In some embodiments, in response to fulfillment of a first execution condition within the set of execution conditions regarding a first candidate cell within the one or more candidate cells when the UE is performing a random access (RA) procedure for timing advance (TA) acquisition for the first candidate cell, the processor of the UE is configured to continue the RA procedure for TA acquisition for the first candidate cell.

In some embodiments, the processor of the UE is further configured to perform at least one of the following: applying a first RRC configuration within the RRC configuration information associated with the first candidate cell; detaching the source cell; or starting a timer for lower layer triggered mobility (LTM).

In some embodiments, a length of the timer for LTM is equal to: the length of the first timer; or the length of the first timer minus elapsed time since starting the RA procedure for TA acquisition.

In some embodiments, the processor of the UE is configured to: in response to the successful completion of the RA procedure for TA acquisition for the first candidate cell, apply a first RRC configuration within the RRC configuration information associated with the first candidate cell.

In some embodiments, the processor of the UE is configured to detach the source cell after: the successful completion of the RA procedure for TA acquisition; or the fulfillment of the first execution condition regarding the first candidate cell.

In some embodiments, the processor of the UE is configured to: continue to evaluate the set of execution conditions in response to that the first RRC configuration associated with the first candidate cell is not applied upon the fulfillment of the first execution condition regarding the first candidate cell; and determine whether the first execution condition regarding the first candidate cell is still fulfilled upon the successfully completion of the RA procedure for TA acquisition for the first candidate cell.

In some embodiments, in response to fulfillment of a first execution condition within the set of execution conditions regarding a first candidate cell within the one or more candidate cells, the processor of the UE is configured to: transmit first information via the transceiver to the first candidate cell to indicate the fulfillment of the first execution condition regarding the first candidate cell.

In some embodiments, the first information is included in a physical uplink share channel (PUSCH) transmission in Message A or Message 3 of an RA procedure performed by the UE.

In some embodiments, in response to fulfillment of a first execution condition within the set of execution conditions regarding a first candidate cell within the one or more candidate cells when the UE is performing an RA procedure for TA acquisition for the first candidate cell or before at least one of a preamble or a sounding reference signal (SRS) is transmitted by the UE for the TA acquisition for the first candidate cell, the processor of the UE is configured to do at least one of the following: stopping the RA procedure for TA acquisition; detaching the source cell; performing an RA procedure to the first candidate cell for switching from the source cell to the first candidate cell; and starting a handover timer.

In some embodiments, in response to that a first execution condition within the set of execution conditions regarding a first candidate cell within the one or more candidate cells is fulfilled for a time period, the processor of the UE is configured to: transmit second information via the transceiver to the first candidate cell to indicate that the UE is about to switch from the source cell to the first candidate cell.

In some embodiments, the time period is equal to or less than a configured time to trigger (TTT).

In some embodiments, the RRC configuration information includes a first condition for starting a TA acquisition procedure, wherein the first condition is generated by a centralized unit (CU) of a base station (BS) or by a source distributed units (DU) of the BS associated with the source cell, and wherein the processor of the UE is configured to start the TA acquisition procedure to the one or more candidate cells in response to fulfillment of the first condition.

In some embodiments, the first condition is that a channel quality of the source cell is less than a threshold.

In some embodiments, the processor of the UE is configured to start a TA acquisition procedure in response to reception of at least one of the following: a candidate cell list, wherein a TA value for each candidate cell within the candidate cell list needs to be gotten by the UE; a dedicated random access channel (RACH) resource for TA acquisition; and an indication to perform the TA acquisition procedure.

In some embodiments, the indication to perform the TA acquisition procedure is configured by a candidate DU of a base station (BS).

In some embodiments, the processor of the UE is configured to perform a compliance check operation for a reference configuration associated with a second candidate cell within the one or more candidate cells.

In some embodiments, the compliance check operation on the reference configuration is performed: in response to reception of the reference configuration; or when the UE performs a TA acquisition procedure; or when the UE performs a cell switching procedure.

In some embodiments, in response to a failure of the compliance check operation on the reference configuration wherein the processor of the UE is configured to: report the failure of the compliance check operation on the reference configuration via the transceiver to the source cell; or perform an RRC re-establishment procedure.

Some embodiments of the present application provide a centralized unit (CU). The CU includes a transceiver and a processor coupled to the transceiver; and the processor is configured to: receive radio resource control (RRC) configuration information associated with one or more candidate cells via the transceiver from one or more candidate distributed units (DU)s of the BS; transmit the RRC configuration information via the transceiver to a user equipment (UE); and receive an RRC configuration complete message via the transceiver from the UE via a source DU of the BS.

In some embodiments, the processor of the CU is configured to transmit a set of execution conditions regarding the one or more candidate cells via the transceiver to the UE, and wherein the set of execution conditions is generated by the CU or the source DU.

In some embodiments, the processor of the CU is configured to: receive a set of Layer1 (L1) execution conditions regarding the one or more candidate cells generated by the source DU via the transceiver from the source DU, in response to that the set of execution conditions is the set of L1 execution conditions; or generate a set of Layer3 (L3) execution conditions regarding the one or more candidate cells, in response to that the set of execution conditions is the set of L3 execution conditions.

In some embodiments, the processor of the CU is configured to transmit a request for the set of L1 execution conditions via the transceiver to the source DU.

In some embodiments, the set of execution conditions or the set of L1 execution conditions or the set of L3 execution conditions includes a first condition for starting a TA acquisition procedure, and wherein the TA acquisition procedure to the one or more candidate cells is started in response to fulfillment of the first condition.

In some embodiments, the first condition is that a channel quality of a source cell of the source DU is less than a threshold.

In some embodiments, the processor of the CU is configured to: receive first information via the transceiver from the UE to indicate that the UE is about to switch from a source cell of the source DU to a first candidate cell within the one or more candidate cells; transmit the first information via the transceiver to a first candidate DU associated with the first candidate cell; receive a physical downlink control channel (PDCCH) transmission via the transceiver from the first candidate DU; and transmit the PDCCH transmission via the transceiver to the UE.

In some embodiments, the processor of the CU is configured to: transmit configuration information regarding time to trigger (TTT) associated with the set of execution conditions via the transceiver to the UE.

Some embodiments of the present application provide a source distributed unit (DU). The source DU includes a transceiver and a processor coupled to the transceiver; and the processor is configured to: receive radio resource control (RRC) configuration information associated with one or more candidate cells via the transceiver from a centralized unit (CU) of the BS; and transmit the RRC configuration information via the transceiver to a user equipment (UE).

In some embodiments, the processor of the source DU is configured to transmit a set of execution conditions regarding the one or more candidate cells via the transceiver to the UE, and wherein the set of execution conditions is generated by the CU and received by the source DU from the CU, or the set of execution conditions is generated by the source DU of the BS.

In some embodiments, in response to that the set of execution conditions is a set of Layer1 (L1) execution conditions regarding the one or more candidate cells, the processor of the source DU is configured to: generate the set of L1 execution conditions; and transmit the set of L1 execution conditions via the transceiver to the CU.

In some embodiments, the processor of the source DU is configured to receive a request for the set of L1 execution conditions via the transceiver from the CU.

In some embodiments, the set of execution conditions or the set of L1 execution conditions includes a first condition for starting a TA acquisition procedure, and wherein the TA acquisition procedure to the one or more candidate cells is started in response to fulfillment of the first condition.

In some embodiments, the first condition is that a channel quality of a source cell of the source DU is less than a threshold.

In some embodiments, the processor of the source DU is configured to: receive first information via the transceiver from the UE to indicate that the UE is about to switch from a source cell of the source DU to a candidate cell within the one or more candidate cells; and transmit the first information via the transceiver to a candidate DU associated with the candidate cell via the CU.

Some embodiments of the present application provide a candidate distributed unit (DU). The candidate DU includes a transceiver and a processor coupled to the transceiver; and the processor is configured to: transmit a set of radio resource control (RRC) configurations associated with at least one candidate cell via the transceiver to a centralized unit (CU) of the BS, wherein the set of RRC configurations does not include an uplink (UL) grant associated with the at least one candidate cell for a user equipment (UE); and transmit a physical downlink control channel (PDCCH) transmission via the transceiver to the UE via the CU after transmitting the set of RRC configurations.

In some embodiments, the processor of the candidate DU is configured to receive first information via the transceiver from the CU to indicate that the UE is about to switch from a source cell to the at least one candidate cell, wherein the first information is received by the CU from the UE via a source DU associated with the source cell, and wherein the PDCCH transmission is transmitted in response to reception of the first information.

In some embodiments, the PDCCH transmission includes at least one of the following: the UL grant associated with the at least one candidate cell for the UE; or a data transmission.

Some embodiments of the present application provide a method performed by a user equipment (UE). The method includes: receiving radio resource control (RRC) configuration information associated with one or more candidate cells from a source cell; and transmitting an RRC configuration complete message in response to accessing one candidate cell within the one or more candidate cells based on the RRC configuration information.

Some embodiments of the present application provide a method performed by a centralized unit (CU). The method includes: receiving radio resource control (RRC) configuration information associated with one or more candidate cells from one or more candidate distributed units (DU)s of the BS; transmitting the RRC configuration information to a user equipment (UE); and receiving an RRC configuration complete message from the UE via a source DU of the BS.

Some embodiments of the present application provide a method performed by a source distributed unit (DU). The method includes: receiving radio resource control (RRC) configuration information associated with one or more candidate cells from a centralized unit (CU) of the BS; and transmitting the RRC configuration information to a user equipment (UE).

Some embodiments of the present application provide a method performed by a candidate distributed unit (DU). The method includes: transmitting a set of radio resource control (RRC) configurations associated with at least one candidate cell to a centralized unit (CU) of the BS, wherein the set of RRC configurations does not include an uplink (UL) grant associated with the at least one candidate cell for a user equipment (UE); and transmitting a physical downlink control channel (PDCCH) transmission to the UE via the CU after transmitting the set of RRC configurations.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (e.g. a base station (BS), a CU, or a DU).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates a schematic diagram of inter-cell Layer1/Layer2 (L1/L2) triggered mobility (LTM) in accordance with some embodiments of the present application.

FIGS. 3-6 illustrate exemplary flowcharts of a cell switching procedure in accordance with some embodiments of the present application.

FIGS. 7-11 illustrate exemplary flowcharts of a cell switching procedure in accordance with some embodiments of the present application.

FIG. 12 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

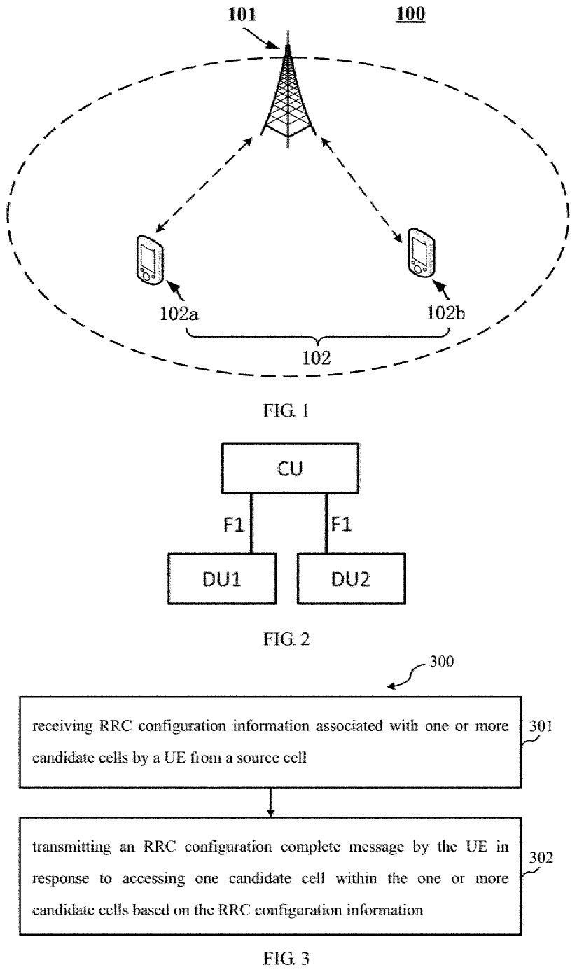

FIG. 1 illustrates a schematic diagram of a wireless communication system in accordance with some embodiments of the present application. As shown in FIG. 1, the wireless communication system 100 includes at least one base station (BS) 101 and at least one user equipment (UE) 102. In particular, the wireless communication system 100 includes one BS 101 and two UE 102 (e.g. UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g. a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g. during a handover procedure for a UE.

UE 102, e.g. UE 102a and UE 102b, should be understood as any type terminal device, which may include computing devices, such as desktop computers, laptop computers, personal digital assistants (PDAs), tablet computers, smart televisions (e.g. televisions connected to the Internet), set-top boxes, game consoles, security systems (including security cameras), vehicle on-board computers, network devices (e.g. routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

In 3GPP Release 18, it has been discussed to support an inter-cell mobility based on Layer1/Layer2 (L1/L2) signaling. In particular, a UE can be provided in advance with configurations from multiple cells, and a BS (e.g. gNB) may switch a UE to a new cell using L1/L2 signaling taking into account the received physical layer measurement result. In accordance with 3GPP standard documents, a BS may consist of a BS-centralized unit (CU) and one or more BS-distributed units (DUs). A BS-CU and a BS-DU are connected via F1 interface which is a logical interface. One BS-DU is connected to only one BS-CU.

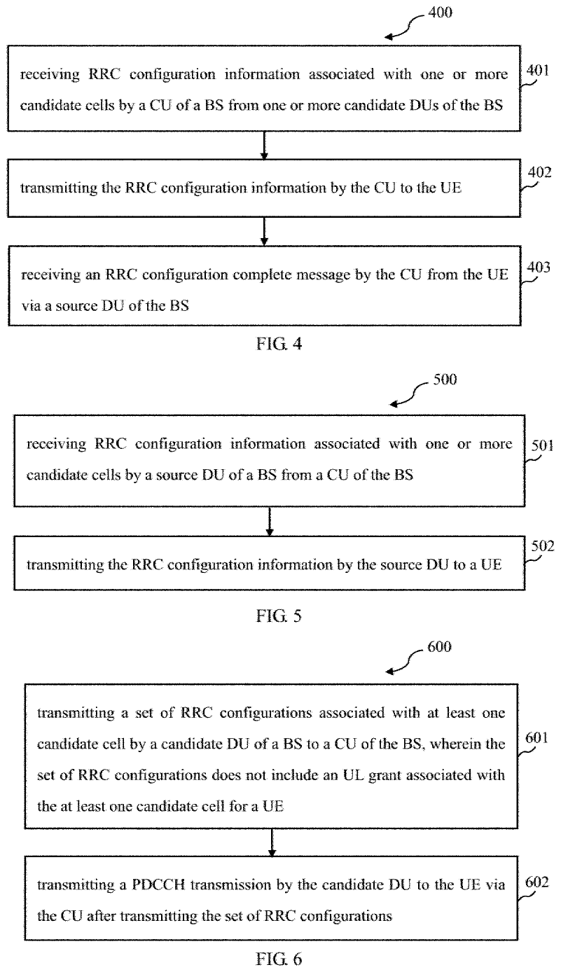

FIG. 2 illustrates a schematic diagram of inter-cell Layer1/Layer2 (L1/L2) triggered mobility (LTM) in accordance with some embodiments of the present application. As shown in FIG. 2, CU may communicate with two DUs, i.e. DU1 or DU2, via F1 interfaces. CU in FIG. 2 may implement legacy mobility decision based on Layer 3 (L3) measurement result. DU1 or DU2 in FIG. 2 may implement L1/L2 triggered mobility decision based on physical layer measurement result.

Compared to legacy L3 based mobility, L1/L2 triggered mobility is considered faster with less processing delay and signaling delay. In legacy L3 based mobility, a CU (e.g. CU as shown in FIG. 2) makes the mobility decision based on received radio resource management (RRM) measurement report. RRC configuration information will be used to trigger L3 based mobility. Different from legacy L3 based mobility, in L1/L2 triggered mobility, a DU (e.g. DU1 or DU2 as shown in FIG. 2) makes the mobility decision based on physical layer measurement result, e.g. carried in a channel state information (CSI) report. A medium access control (MAC) control element (CE) may be used to trigger LTM. Besides, in legacy L3 based mobility, the handover command is sent via an RRC message from the CU to a UE, while in L1/L2 triggered mobility, the “handover” command is sent via L1/L2 signaling (e.g. downlink control information (DCI) or a MAC CE) from the DU to a UE.

Currently, details regarding a condition-based cell switching procedure have not been discussed in 3GPP 5G technology yet, and several issues related to a condition-based cell switching procedure need to be solved. The embodiments of the present application aim to solve such issues. Some embodiments of the present application may be applicable for a case of “lower layer triggered mobility” or “L1/L2 triggered mobility”, and the abbreviation of at least one of them may be “LTM”. In an LTM case, a UE may access a serving BS (e.g. a serving gNB). The UE may report Layer3 (L3) measurement result(s) based on the configuration from the serving gNB. If the serving gNB, e.g. a CU of the serving gNB, decides to switch the UE to a candidate cell based on the measurement result(s), the serving gNB may request target DU(s) to prepare the configuration for one or more candidate cells. After receiving the candidate cell configuration from a target DU of the serving gNB, the serving gNB may transmit an RRC reconfiguration message including ID information of one or more candidate cells to the UE. For example, the CU may transmit the RRC reconfiguration message to the UE via a source DU of the serving gNB. The UE may transmit an RRC reconfiguration complete message to the serving gNB (e.g. CU) via the source DU. The UE may ensure UL synchronization or DL synchronization before receiving a cell switch command. For example, the UE may get or acquire a TA value via a random access (RA) or preamble transmission. The UE may report Layer1 (L1) measurement result(s) for a dynamic switching purpose. The serving gNB, e.g. the source DU, may transmit a cell switch command, e.g. a MAC CE or DCI. The UE can apply the RRC reconfiguration message and start a timer upon receiving the lower layer command.

More specifically, some embodiments of the present application introduce a new case in which a condition for cell switching is fulfilled when a UE is performing an RA procedure for TA acquisition. Some embodiments of the present application introduce a new case in which a condition for cell switching is fulfilled when a UE is performing TA acquisition (e.g. transmitting a preamble or a SRS). Some embodiments of the present application study a mechanism to distinguish the following two cases: a case in which a UE only acquires early TA value(s) and moves back to the “old” source cell after TA acquisition, for example, an RA procedure for early TA acquisition ends e.g. after receiving an RAR message; and another case in which a UE acquires early TA value(s) and applies RRC configuration information from a target cell and switches from a source cell to the target cell. In some embodiments of the present application, a TA acquisition procedure may also be named as “an early TA acquisition procedure”, “a procedure for acquiring a TA value”, “a procedure for acquiring an early TA value”, or the like.

Some embodiments of the present application study when a condition for cell switching is fulfilled if no uplink (UL) grant is (pre-)configured and how a candidate DU can know the timing of transmitting a PDCCH transmission for this UE. Some embodiments of the present application propose a condition-based early TA acquisition procedure. Some embodiments of the present application propose a compliance check operation for a UE which stores the reference configuration as a separate configuration.

Some embodiments of the present application propose a procedure between a CU and a candidate DU for early TA acquisition which is triggered by RRC configuration information. For instance, an early TA request may be sent from the CU to candidate DU(s). Then, a candidate DU may configure a RACH resource for early TA acquisition to a UE. The dedicated RACH resource is generated by candidate DU and transmitted to CU. The UE performs early TA acquisition procedure based on at least one of the followings: a candidate cell list to get early TA, a dedicated RACH resource which is used to implicitly indicate that early TA acquisition is needed; an indication to perform early TA which is included in RRC configuration for candidate cell that is contained in an RRC reconfiguration message.

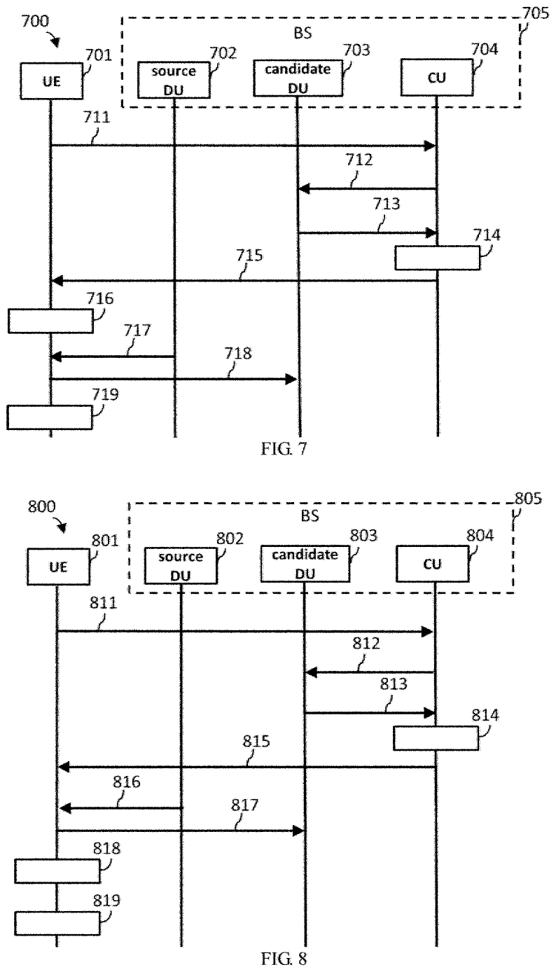

In particular, in embodiments of FIGS. 3-11 of the present application, both inter-DU mobility scenario and intra-DU mobility scenario are considered, e.g. inter-gNB-DU LTM or intra-gNB-DU LTM. Inter-DU mobility means that a connection to a CU remains the same, while a UE may change from a source cell related to a source DU to a target cell related to a target DU due to mobility, while both the source DU and the target DU are managed by the CU. Intra-DU mobility means that a connection to a CU remains the same, while a UE may change from a source cell to a target cell related to the same DU due to mobility. More details will be illustrated in following text in combination with the appended drawings.

FIG. 3 illustrates an exemplary flowchart of transmitting a request for cell switching in accordance with some embodiments of the present application. The exemplary method 300 in the embodiments of FIG. 3 may be performed by a UE (e.g. UE 102, UE 701, UE 801, UE 901, UE 1001, or UE 1101 as shown and illustrated in any of FIGS. 1 and 7-11). Although described with respect to a UE, it should be understood that other devices may be configured to perform a method similar to that of FIG. 3. Details described in all other embodiments of the present application are applicable for the embodiments of FIG. 3. Moreover, details described in the embodiments of FIG. 3 are applicable for all the embodiments of FIGS. 1, 2, and 4-11.

In the exemplary method 300 as shown in FIG. 3, in operation 301, a UE may receive RRC configuration information associated with one or more candidate cells from a source cell. The RRC configuration information may be used for a cell switching procedure of the UE, and may be named as “RRC configuration information for cell switching” or the like.

In operation 302, the UE may transmit an RRC configuration complete message in response to accessing one candidate cell within the one or more candidate cells based on the RRC configuration information.

In some embodiments, the UE may receive a set of execution conditions regarding the one or more candidate cells from the source cell. The set of execution conditions may be generated by a CU of a BS (e.g. CU, CU 704, CU 804, CU 904, CU 1004, or CU 1104 as shown and illustrated in any of FIGS. 2 and 7-11) or by a source DU of the BS associated with the source cell. The set of execution conditions may be used for a cell switching procedure of the UE, and may be named as “execution conditions for cell switching” or the like. In an embodiment, the set of execution conditions may be associated with a conditional handover (CHO) procedure. In another embodiment, the set of execution conditions may be associated with a conditional primary secondary cell group cell addition or change (CPAC) procedure.

In some embodiments, the UE may receive configuration information regarding at least one of a timer (denoted as Timer #1 for simplicity) or another timer (denoted as Timer #2 for simplicity). Timer #1 may be configured to be used when a TA value associated with the one or more candidate cells is unavailable at the UE. Timer #2 may be configured to be used when the TA value is available at the UE.

In some embodiments, the UE may start to evaluate an execution condition within the set of execution conditions upon the reception of the RRC configuration information.

In some embodiments, in response to fulfillment of an execution condition (denoted as execution condition #1 for simplicity) within the set of execution conditions regarding a candidate cell (denoted as candidate cell #1 for simplicity) within the one or more candidate cells when the UE is performing an RA procedure for TA acquisition for candidate cell #1, the UE may continue the RA procedure for TA acquisition for candidate cell #1.

In some embodiments, the UE may perform at least one of the following:
(1) applying an RRC configuration (denoted as RRC configuration #1 for simplicity) within the RRC configuration information associated with candidate cell #1, e.g. upon the fulfillment of execution condition #1 regarding candidate cell #1;
(2) detaching the source cell; or
(3) starting a timer for LTM (denoted as Timer #0 for simplicity).

In some embodiments, a length of Timer #0 is equal to the length of Timer #1. In some other embodiments, a length of Timer #0 is equal to “the length of Timer #1” minus “elapsed time since starting the RA procedure for TA acquisition”.

In some embodiments, in response to the successful completion of the RA procedure for TA acquisition for candidate cell #1, the UE may apply RRC configuration #1 within the RRC configuration information associated with candidate cell #1. That is, the UE does not apply RRC configuration #1 regarding candidate cell #1 upon fulfillment of execution condition #1 regarding candidate cell #1, but may postpone to apply RRC configuration #1 regarding candidate cell #1 until successful completion of the RA procedure for TA acquisition.

In some embodiments, the UE may detach the source cell after the successful completion of the RA procedure for TA acquisition. In some other embodiments, the UE may detach the source cell after the fulfillment of execution condition #1 regarding candidate cell #1.

In some embodiments, the UE may continue to evaluate the set of execution conditions if RRC configuration #1 associated with candidate cell #1 is not applied upon the fulfillment of execution condition #1 regarding candidate cell #1, and determine whether execution condition #1 regarding candidate cell #1 is still fulfilled upon the successfully completion of the RA procedure for TA acquisition for candidate cell #1. If execution condition #1 regarding candidate cell #1 is still fulfilled, the UE may apply execution condition #1 for cell switching regarding candidate cell #1.

In some embodiments, in response to fulfillment of execution condition #1 within the set of execution conditions regarding candidate cell #1 within the one or more candidate cells, the UE may transmit information (denoted as information #1 for simplicity), which indicates the fulfillment of execution condition #1 regarding candidate cell #1, to candidate cell #1. In an embodiment, information #1 may be included in a PUSCH transmission in Message A or Message 3 of an RA procedure performed by the UE.

In some embodiments, in response to fulfillment of execution condition #1 within the set of execution conditions regarding candidate cell #1 within the one or more candidate cells when the UE is performing an RA procedure for TA acquisition for candidate cell #1 or before at least one of a preamble or a sounding reference signal (SRS) is transmitted by the UE for the TA acquisition for candidate cell #1, the UE may do at least one of the following:
(1) stopping the RA procedure for TA acquisition;
(2) detaching the source cell;
(3) performing an RA procedure to candidate cell #1 for switching from the source cell to candidate cell #1; and
(4) starting a handover timer (e.g. T304 as specified in 3GPP document).

In some embodiments, if execution condition #1 regarding candidate cell #1 is fulfilled for a time period, the UE may transmit information (denoted as information #2 for simplicity), which indicates that the UE is about to switch from the source cell to candidate cell #1, to candidate cell #1. In an embodiment, the time period is equal to or less than a configured time to trigger (TTT). In some embodiments, the UE may receive configuration information regarding TTT associated with the set of execution conditions. In an embodiment, information #2 may be transmitted by the UE if the UE is not configured a UL grant associated with candidate cell #1. Information #2 may be transferred by the source DU to candidate cell #1 via the CU.

In some embodiments, the RRC configuration information received in operation 301 includes a condition for starting a TA acquisition procedure. The condition may be generated by a CU of a BS or by a source DU of the BS associated with the source cell. The UE may start the TA acquisition procedure to the one or more candidate cells in response to fulfillment of the condition. In an embodiment, the condition is that a channel quality of the source cell is less than a threshold.

In some embodiments, the UE may receive a PDCCH transmission from candidate cell #1. For instance, the PDCCH transmission may include at least one of: (1) a UL grant associated with candidate cell #1 for the UE; or (2) a data transmission for the UE.

In some embodiments, the UE may start a TA acquisition procedure in response to reception of at least one of the following:
(1) a candidate cell list, wherein a TA value for each candidate cell within the candidate cell list needs to be gotten by the UE;
(2) a Dedicated Rach Resource for Ta Acquisition; and
(3) an indication to perform the TA acquisition procedure. In an embodiment, the indication to perform the TA acquisition procedure is configured by a candidate DU of a BS. A specific example is described in the embodiments of FIG. 11 as follows.

In some embodiments, the UE may perform a compliance check operation for a reference configuration associated with a candidate cell within the one or more candidate cells. In an embodiment, the compliance check operation on the reference configuration is performed:
(1) in response to reception of the reference configuration; or
(2) when the UE performs a TA acquisition procedure; or
(3) when the UE performs a cell switching procedure.

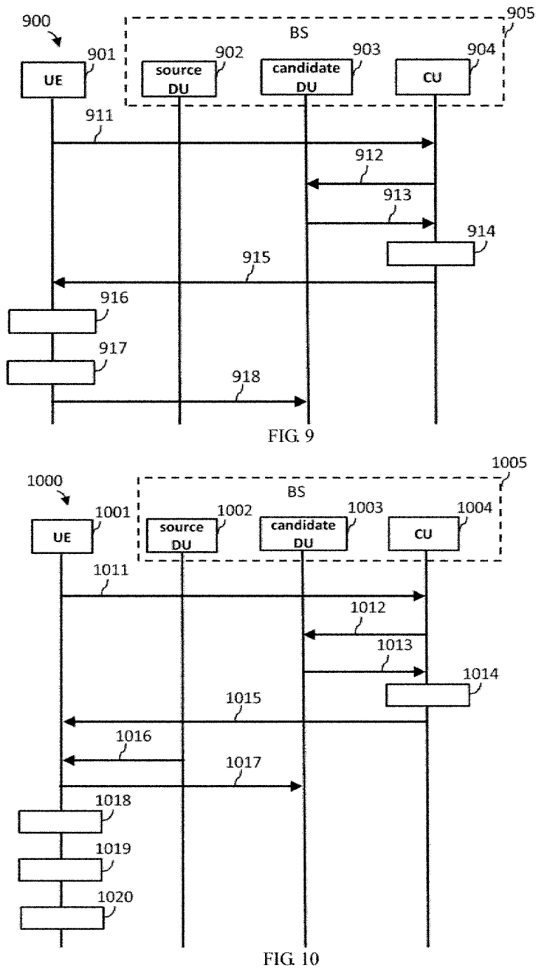

In some embodiments, in response to a failure of the compliance check operation on the reference configuration, the UE may report the failure of the compliance check operation on the reference configuration to the source cell or the UE may perform an RRC re-establishment procedure. A specific example is described in the embodiments of FIG. 7 as follows.

FIG. 4 illustrates an exemplary flowchart of receiving a cell switching procedure in accordance with some embodiments of the present application. The exemplary method 400 in the embodiments of FIG. 4 may be performed by a CU of a BS (e.g. CU, CU 704, CU 804, CU 904, CU 1004, or CU 1104 as shown and illustrated in any of FIGS. 2 and 7-11). Although described with respect to a CU, it should be understood that other devices may be configured to perform a method similar to that of FIG. 4. Details described in all other embodiments of the present application are applicable for the embodiments of FIG. 4. Moreover, details described in the embodiments of FIG. 4 are applicable for all the embodiments of FIGS. 1-3 and 5-11.

In the exemplary method 400 as shown in FIG. 4, in operation 401, a CU of a BS (e.g. CU 904 or CU 1004 as shown and illustrated in FIG. 9 or FIG. 10) may receive RRC configuration information associated with one or more candidate cells from one or more candidate DUs of the BS. In operation 402, the CU may transmit the RRC configuration information to a UE (e.g. UE 901 or UE 1001 as shown and illustrated in FIG. 9 or FIG. 10). In operation 403, the CU may receive an RRC configuration complete message from the UE via a source DU of the BS (e.g. source DU 902 or source DU 1002 as shown and illustrated in FIG. 9 or FIG. 10).

In some embodiments, the CU may transmit a set of execution conditions regarding the one or more candidate cells to the UE. The set of execution conditions may be generated by the CU or the source DU.

In some embodiments, the CU may receive a set of Layer1 (L1) execution conditions regarding the one or more candidate cells generated by the source DU from the source DU, if the set of execution conditions is the set of L1 execution conditions. For instance, the set of L1 execution conditions may be received in an F1AP message. In an embodiment, the CU may transmit a request for the set of L1 execution conditions to the source DU.

In some other embodiments, the CU may generate a set of Layer3 (L3) execution conditions regarding the one or more candidate cells, if the set of execution conditions is the set of L3 execution conditions.

In some embodiments, the set of execution conditions or the set of L1 execution conditions or the set of L3 execution conditions includes a condition for starting a TA acquisition procedure. The TA acquisition procedure to the one or more candidate cells may be started, e.g. by the UE, in response to fulfillment of the condition. In an embodiment, the condition is that a channel quality of a source cell of the source DU is less than a threshold.

In some embodiments, the CU may receive information (e.g. information #2 as described in the embodiments of FIG. 3) from the UE to indicate that the UE is about to switch from a source cell of the source DU to a candidate cell (e.g. candidate cell #1 as described in the embodiments of FIG. 3) within the one or more candidate cells, transmit the information to a candidate DU (e.g. candidate DU 903 or candidate DU 1003 as shown and illustrated in FIG. 9 or FIG. 10) associated with the candidate cell, receive a PDCCH transmission from the candidate DU, and transmit the PDCCH transmission to the UE. For instance, the PDCCH transmission may include at least one of: (1) a UL grant associated with the candidate cell for the UE; or (2) a data transmission for the UE.

In some embodiments, the CU may transmit configuration information TTT associated with the set of execution conditions to the UE.

In some embodiments, the CU may transmit a request for a TA value (e.g. an early TA request) to the one or more candidate DUs. Specific examples are described in the embodiments of FIG. 9 or FIG. 10 as follows.

FIG. 5 illustrates an exemplary flowchart of transmitting a cell switching procedure in accordance with some embodiments of the present application. The exemplary method 500 in the embodiments of FIG. 5 may be performed by a source DU of a BS (e.g. DU1, DU2, source DU 702, source DU 802, source DU 902, source DU 1002, or source DU 1102 as shown and illustrated in any of FIGS. 2 and 7-11). Although described with respect to a source DU, it should be understood that other devices may be configured to perform a method similar to that of FIG. 5. Details described in all other embodiments of the present application are applicable for the embodiments of FIG. 5. Moreover, details described in the embodiments of FIG. 5 are applicable for all the embodiments of FIGS. 1-4 and 6-11.

In the exemplary method 500 as shown in FIG. 5, in operation 501, a source DU (e.g. source DU 902 or source DU 1002 as shown and illustrated in FIG. 9 or FIG. 10) may receive RRC configuration information associated with one or more candidate cells from a CU of the BS (e.g. CU 904 or CU 1004 as shown and illustrated in FIG. 9 or FIG. 10). In operation 502, the source DU may transmit the RRC configuration information to a UE (e.g. UE 901 or UE 1001 as shown and illustrated in FIG. 9 or FIG. 10).

In some embodiments, the source DU may transmit a set of execution conditions regarding the one or more candidate cells to the UE. In an embodiment, the set of execution conditions is generated by the CU and received by the source DU from the CU, e.g. the set of execution conditions is a set of Layer3 (L3) execution conditions regarding the one or more candidate cells. In another embodiment, the set of execution conditions is generated by the source DU of the BS. For instance, if the set of execution conditions is a set of Layer1 (L1) execution conditions regarding the one or more candidate cells, the source DU may generate the set of L1 execution conditions, and transmit the set of L1 execution conditions to the CU. For example, the set of L1 execution conditions may be transmitted in an F1AP message. In an embodiment, the source DU may receive a request for the set of L1 execution conditions via the transceiver from the CU.

In some embodiments, the set of execution conditions or the set of L1 execution conditions includes a condition for starting a TA acquisition procedure. The TA acquisition procedure to the one or more candidate cells may be started, e.g. by the UE, in response to fulfillment of the condition. In an embodiment, the condition is that a channel quality of a source cell of the source DU is less than a threshold.

In some embodiments, the source DU may receive information (e.g. information #2 as described in the embodiments of FIG. 3) from the UE to indicate that the UE is about to switch from a source cell of the source DU to a candidate cell (e.g. candidate cell #1 as described in the embodiments of FIG. 3) within the one or more candidate cells, and transmit the information to a candidate DU (e.g. candidate DU 903 or candidate DU 1003 as shown and illustrated in FIG. 9 or FIG. 10) associated with the candidate cell via the CU. Specific examples are described in the embodiments of FIG. 9 or FIG. 10 as follows.

FIG. 6 illustrates an exemplary flowchart of transmitting a cell switching procedure in accordance with some embodiments of the present application. The exemplary method 600 in the embodiments of FIG. 6 may be performed by a candidate DU of a BS (e.g. DU1, DU2, candidate DU 703, candidate DU 803, candidate DU 903, candidate DU 1003, or candidate DU 1103 as shown and illustrated in any of FIGS. 2 and 7-11). Although described with respect to a source DU, it should be understood that other devices may be configured to perform a method similar to that of FIG. 6. Details described in all other embodiments of the present application are applicable for the embodiments of FIG. 6. Moreover, details described in the embodiments of FIG. 6 are applicable for all the embodiments of FIGS. 1-4 and 6-11.

In the exemplary method 600 as shown in FIG. 6, in operation 601, a candidate DU (denoted as candidate DU #1 for simplicity, e.g. candidate DU 1003 as shown and illustrated in FIG. 10) may transmit a set of RRC configurations associated with at least one candidate cell to a CU of the BS (e.g. CU 1004 as shown and illustrated in FIG. 10). The set of RRC configurations does not include a UL grant associated with the at least one candidate cell for a UE (e.g. UE 1001 as shown and illustrated in FIG. 10). In operation 602, candidate DU #1 may transmit a PDCCH transmission to the UE via the CU after transmitting the set of RRC configurations.

In some embodiments, candidate DU #1 may receive information (e.g. information #2 as described in the embodiments of FIG. 3) from the CU to indicate that the UE is about to switch from a source cell to the at least one candidate cell. The information may be received by the CU from the UE via a source DU associated with the source cell. The PDCCH transmission may be transmitted by candidate DU #1 in response to reception of the information.

In some embodiments, the PDCCH transmission includes at least one of the following: the UL grant associated with the at least one candidate cell for the UE; or a data transmission. A specific example is described in the embodiments of FIG. 10 as follows.

The following text describes specific embodiments of the flowchart as shown and illustrated in any of FIGS. 3-6 or the exemplary flowchart performed by a candidate DU as described above. It should be appreciated by persons skilled in the art that the sequence of the operations in any of exemplary flowcharts 700, 800, 900, 1000, and 1100 in FIGS. 7-11 may be changed and some of the operations in any of exemplary flowcharts 700, 800, 900, 1000, and 1100 in FIGS. 7-11 may be eliminated or modified, without departing from the spirit and scope of the disclosure.

FIG. 7 illustrates an exemplary flowchart of a cell switching procedure in accordance with some embodiments of the present application. Details described in all other embodiments of the present application are applicable for the embodiments shown in FIG. 7.

As shown in FIG. 7, BS 705 is in CU-DU architecture, and includes CU 704, source DU 702, and candidate DU 703. In the embodiments shown in FIG. 7, a cell switch or change of UE 701 may refer to an Intra-DU case in which a source cell and a target cell in the same DU or refer to an Inter-DU case in which a source cell and a target cell are located at different DUs. For instance, the flowchart 700 as shown in FIG. 7 only shows a cell change in an Inter-DU case for the exemplary purpose.

In the exemplary flowchart 700 as shown in FIG. 7, in operation 711, UE 701 may access the serving BS (e.g. gNB) and send a measurement report to the serving BS, for example, BS 705. The serving BS may include a CU (e.g. gNB-CU) and one or more DUs (e.g. gNB-DUs). A serving cell is associated with a CU and a DU. There is an F1 interface between the DU and the CU. For example, as shown in FIG. 7, BS 705 includes CU 704, source DU 702, and candidate DU 703. BS 705 may include one or more other candidate DUs (not shown).

In operation 712, CU 704 may determine to initiate inter-cell L1/L2 based triggered mobility (LTM) configuration and transmit a request message, e.g. a UE CONTEXT SETUP REQUEST message to one or more candidate DUs (e.g. candidate DU 703) which are associated with one or more candidate cells. For example, the request message may be named as “a request for cell switching” or “the request of LTM configuration” or the like, and may include ID information of candidate cell(s).

In operation 713, if candidate DU 703 decides to accept the request of LTM configuration, candidate DU 703 may generate lower layer RRC configuration for the accepted one or more candidate cell(s) and send a response message to CU 704 including the generated lower layer RRC configuration. The response message could be a UE CONTEXT SETUP RESPONSE message.

In operation 714, CU 704 may generate an RRC reconfiguration message based on the configuration for the accepted candidate cell(s) received from candidate DU 703.

In operation 714, there may be different embodiments in different scenarios. In some embodiments, in a scenario based on CHO or CPAC RRC framework, CU 704 may generate and configures L3 condition for cell switching based on L3 measurement result framework. In this scenario, a CHO procedure or a CPAC procedure may be enhanced to support a TA acquisition procedure and an early DL synchronization procedure. Namely, a network can request UE 601 to perform a TA acquisition procedure and an early DL synchronization procedure to a candidate cell when configuration information regarding CHO or CPAC associated with the candidate cell is configured.

In some other embodiments, in a scenario based on LTM RRC framework, source DU 702 may generate L1 condition for cell switching based on L1 measurement framework. For instance, similar to L3 measurement framework, the L1 measurement framework includes resource settings, reporting settings, and/or trigger states. The L1 condition for cell switching may be used to replace the explicit cell switching command for LTM. A LTM framework, e.g. RRC modeling, can be reused.

In an embodiment, candidate DU 703 may generate and transmit L1 condition for cell switching to CU 704 via F1AP message. The L1 condition for cell switching can be requested by CU 704. Then, CU 704 may generate an RRC reconfiguration message containing both the L1 condition received from candidate DU 703 and RRC configuration information of the candidate cell(s), and may send the RRC reconfiguration message to UE 701.

For example, the L1 condition for cell switching associated with a candidate cell could be one of the following:
(1) The channel quality of the candidate cell becomes offset better than the channel quality of the serving cell.
(2) The channel quality of the candidate cell is better than a configured threshold #1, and the channel quality of the serving cell is less than a configured threshold #2. The channel quality may be calculated in a physical layer.

In operation 715, CU 704 may transmit the RRC reconfiguration message associated with the candidate cell(s) for LTM configuration to UE 701 via source DU 702. For instance, the RRC reconfiguration message includes the RRC configuration associated with candidate cell(s) and the condition for cell switching, e.g. L1 or L3 condition. In some embodiments, a reference configuration associated with a candidate cell may be configured in the RRC reconfiguration message as well.

In operation 716, UE 701 may perform compliance check for the RRC reconfiguration message. If the RRC reconfiguration message includes a reference configuration associated with a candidate cell (e.g. a candidate cell of candidate DU 703), when UE 701 performs the compliance check for the RRC reconfiguration message, UE 701 may also check the compliance of the reference configuration. In some embodiments, the compliance check on the reference configuration can happen when UE 701 receives the reference configuration or when UE 701 performs a TA acquisition procedure or when UE 701 performs a cell switching procedure. If the compliance check on the reference configuration fails, UE 701 may report the failure of the compliance check on the reference configuration or UE 701 may perform an RRC reestablishment procedure.

In operation 717, UE 701 may receive information to trigger TA acquisition to a candidate cell within the candidate cell(s) from source DU 702. In some embodiments, the information could be DCI, a MAC CE or RRC signaling. If the information is DCI, it could be a PDCCH order.

In operation 718, UE 701 may transmit a signal (e.g. a sequence, for example, a dedicated preamble or a SRS) for TA acquisition, e.g. to candidate DU 703 and/or other candidate DU(s) (not shown).

In operation 719, the condition for cell switching associated with a candidate cell (e.g. a candidate cell of candidate DU 703) may be fulfilled when UE 701 is performing an RA procedure for TA acquisition. There may be following two options in different embodiments, i.e. Option 1 and Option 2.

Option 1: when the condition for cell switching associated with the candidate cell is fulfilled, UE 701 may continue the RA procedure for TA acquisition. In Option 1, there may be following two options in different embodiments, i.e. Option 1-1 and Option 1-2.
(1) Option 1-1: if UE 701 continues the RA procedure for TA acquisition, UE 701 may directly apply the RRC configuration information for the candidate cell.
   a) In some embodiments, UE 701 may also detach the source cell and start a timer (e.g. Timer #0 as described in the embodiments of FIG. 3).
   b) In some embodiments, two timers may be configured for UE 701. For instance, a timer (e.g. Timer #1 as described in the embodiments of FIG. 3) is configured for a case that an early TA value is not available or invalid at UE 701. Another timer (e.g. Timer #2 as described in the embodiments of FIG. 3) is configured for a case that an early TA value is available or valid for a cell switching procedure without performing an RA procedure to a target cell.
   c) The length of Timer #0 can be Timer #1, or can be the length of Timer #1 minus the elapsed duration of the RA procedure for TA acquisition.
(2) Option 1-2: if UE 701 continues the RA procedure for TA acquisition, the RRC configuration information for the candidate cell is postponed to be applied until the RA procedure for TA acquisition is successful.
   a) In some embodiments, when UE 701 successfully completes the TA acquisition procedure, UE 701 may perform the cell switching (e.g. to the candidate cell of candidate DU 703) and start a timer (e.g. Timer #2).
   b) In some embodiments, UE 701 may detach the source cell when successfully completes the TA acquisition procedure. In some other embodiments, UE 701 may detach the source cell when the condition for cell switching is fulfilled.
   c) In some embodiments, UE 701 continues to evaluate the condition for cell switching when “applying the RRC configuration information for the candidate cell” is postponed. When the RA procedure for TA acquisition is successful, UE 701 may be expected to determine if the condition for cell switching is still fulfilled. If the condition for cell switching is still fulfilled, UE 701 may apply the RRC configuration information for the candidate cell.

In Option 1, in some embodiments, UE 701 may indicate to a candidate DU (e.g. candidate DU 703) that the condition for cell switching is fulfilled. UE 701 may transmit an indication, and the indication can be transmitted via a PUSCH transmission in Message A or Message 3 of an RA procedure.

Option 2: when the condition for cell switching associated with the candidate cell is fulfilled, UE 701 may stop the TA acquisition procedure and/or may detach the source cell. UE 701 may start a handover timer (e.g. T304) and perform an RA procedure for cell switching, e.g. to a candidate cell of candidate DU 703.

FIG. 8 illustrates another exemplary flowchart of a cell switching procedure in accordance with some embodiments of the present application. Details described in all other embodiments of the present application are applicable for the embodiments shown in FIG. 8.

As shown in FIG. 8, BS 805 is in CU-DU architecture, and includes CU 804, source DU 802, and candidate DU 803. In the embodiments shown in FIG. 8, a cell switch or change of UE 801 may refer to an Intra-DU case in which a source cell and a target cell in the same DU or refer to an Inter-DU case in which a source cell and a target cell are located at different DUs. For instance, the flowchart 800 as shown in FIG. 8 only shows a cell change in an Inter-DU case for the exemplary purpose.

In the exemplary flowchart 800 as shown in FIG. 8, in operation 811, UE 801 may access the serving BS (e.g. gNB) and send a measurement report to the serving BS, for example, BS 805. The serving BS may include a CU (e.g. gNB-CU) and one or more DUs (e.g. gNB-DUs). A serving cell is associated with a CU and a DU. There is an F1 interface between the DU and the CU. For example, as shown in FIG. 8, BS 805 includes CU 804, source DU 802, and candidate DU 803. BS 805 may include one or more other candidate DUs (not shown).

In operation 812, CU 804 may determine to initiate inter-cell L1/L2 based triggered mobility (LTM) configuration and transmit a request message, e.g. a UE CONTEXT SETUP REQUEST message, to candidate DU(s) (e.g. candidate DU 803) which are associated with candidate cell(s). For example, the request message may be named as “a request for cell switching” or “the request of LTM configuration” or the like, and may include ID information of candidate cell(s).

In operation 813, if candidate DU 803 decides to accept the request of LTM configuration, candidate DU 803 may generate lower layer RRC configuration for the accepted one or more candidate cell(s) and send a response message to CU 804 including the generated lower layer RRC configuration. The response message could be a UE CONTEXT SETUP RESPONSE message.

In operation 814, CU 804 may generate an RRC reconfiguration message based on the configuration for the accepted candidate cell(s) received from candidate DU 803.

In operation 814, there may be different embodiments in different scenarios. In some embodiments, in a scenario based on CHO or CPAC RRC framework, CU 804 may generate and configures L3 condition for cell switching based on L3 measurement result framework. In this scenario, a CHO procedure or a CPAC procedure may be enhanced to support a TA acquisition procedure and an early DL synchronization procedure. Namely, a network can request UE 601 to perform a TA acquisition procedure and an early DL synchronization procedure to a candidate cell when configuration information regarding CHO or CPAC associated with the candidate cell is configured.

In some other embodiments, in a scenario based on LTM RRC framework, source DU 802 may generate L1 condition for cell switching based on L1 measurement framework. For instance, similar to L3 measurement framework, the L1 measurement framework includes resource settings, reporting settings, and/or trigger states. The L1 condition for cell switching may be used to replace the explicit cell switching command for LTM. LTM framework, e.g. RRC modeling, can be reused.

In an embodiment, candidate DU 803 may generate and transmit L1 condition for cell switching to CU 804 via F1AP message. The L1 condition for cell switching can be requested by CU 804. Then, CU 804 may generate an RRC reconfiguration message containing both the L1 condition received from candidate DU 803 and RRC configuration information of the candidate cell(s), and may send the RRC reconfiguration message to UE 801.

For example, the L1 condition for cell switching associated with a candidate cell could be one of the following:
(1) The channel quality of the candidate cell becomes offset better than the channel quality of the serving cell.
(2) The channel quality of the candidate cell is better than a configured threshold #1, and the channel quality of the serving cell is less than a configured threshold #2. The channel quality may be calculated in a physical layer.

In operation 815, CU 804 may transmit the RRC reconfiguration message associated with the candidate cell(s) for LTM configuration to UE 801 via source DU 802. For instance, the RRC reconfiguration message includes the RRC configuration associated with candidate cell(s) and the condition for cell switching, e.g. L1 or L3 condition configured by candidate DU 803.

In operation 816, UE 801 may receive information, which triggers TA acquisition to a candidate cell within the candidate cell(s) (e.g. a candidate cell of candidate DU 803), from source DU 802. In some embodiments, the information could be DCI, a MAC CE or RRC signaling. If the information is DCI, it could be a PDCCH order.

In operation 817, UE 801 may transmit a signal (e.g. a sequence, for instance, a dedicated preamble or a SRS) for TA acquisition, e.g. to candidate DU 803 and/or other candidate DU(s) (not shown).

In operation 818, the condition for cell switching is fulfilled when UE 801 is triggered to transmit a preamble or a SRS for TA acquisition. In some embodiments, if UE 801 is triggered to transmit a preamble or a SRS, the condition may be fulfilled before the preamble or the SRS is transmitted.

In operation 819, UE 801 may stop the TA acquisition procedure. UE 801 may detach the source cell and perform an RA procedure to switch to a candidate cell (i.e. a target cell), e.g. of candidate DU 803.

FIG. 9 illustrates another exemplary flowchart of a cell switching procedure in accordance with some embodiments of the present application. Details described in all other embodiments of the present application are applicable for the embodiments shown in FIG. 9.

As shown in FIG. 9, BS 905 is in CU-DU architecture, and includes CU 904, source DU 902, and candidate DU 903. In the embodiments shown in FIG. 9, a cell switch or change of UE 901 may refer to an Intra-DU case in which a source cell and a target cell in the same DU or refer to an Inter-DU case in which a source cell and a target cell are located at different DUs. For instance, the flowchart 900 as shown in FIG. 9 only shows a cell change in an Inter-DU case for the exemplary purpose.

In the exemplary flowchart 900 as shown in FIG. 9, in operation 911, UE 901 may access the serving BS (e.g. gNB) and send a measurement report to the serving BS, for example, BS 905. The serving BS may include a CU (e.g. gNB-CU) and one or more DUs (e.g. gNB-DUs). A serving cell is associated with a CU and a DU. There is an F1 interface between the DU and the CU. For example, as shown in FIG. 9, BS 905 includes CU 904, source DU 902, and candidate DU 903. BS 905 may include one or more other candidate DUs (not shown in FIG. 9).

In operation 912, CU 904 may determine to initiate inter-cell L1/L2 based triggered mobility (LTM) configuration and transmit a request message, e.g. a UE CONTEXT SETUP REQUEST message, to candidate DU(s) (e.g. candidate DU 903) which are associated with candidate cell(s). For example, the request message may be named as “a request for cell switching” or “the request of LTM configuration” or the like, and may include ID information of candidate cell(s).

In operation 913, if candidate DU 903 decides to accept the request of LTM configuration, candidate DU 903 may generate lower layer RRC configuration for the accepted one or more candidate cell(s) and send a response message to CU 904 including the generated lower layer RRC configuration. The response message could be a UE CONTEXT SETUP RESPONSE message.

In operation 914, CU 904 may generate an RRC reconfiguration message based on the configuration for the accepted candidate cell(s) received from candidate DU 903.

In operation 914, there may be different embodiments in different scenarios. In some embodiments, in a scenario based on a CHO or CPAC RRC framework, CU 904 may generate and configures L3 condition for cell switching based on L3 measurement result framework. In this scenario, a CHO procedure or a CPAC procedure may be enhanced to support a TA acquisition procedure and an early DL synchronization procedure. Namely, a network can request UE 601 to perform a TA acquisition procedure and an early DL synchronization procedure to a candidate cell when configuration information regarding CHO or CPAC associated with the candidate cell is configured.

In some other embodiments, in a scenario based on LTM RRC framework, source DU 902 may generate L1 condition for cell switching based on L1 measurement framework. For instance, similar to L3 measurement framework, the L1 measurement framework includes resource settings, reporting settings, and/or trigger states. The L1 condition for cell switching may be used to replace the explicit cell switching command for LTM. LTM framework, e.g. RRC modeling, can be reused.

In an embodiment, candidate DU 903 may generate and transmit L1 condition for cell switching to CU 904 via F1AP message. The L1 condition for cell switching can be requested by CU 904. Then, CU 904 may generate an RRC reconfiguration message containing both the L1 condition received from candidate DU 903 and RRC configuration information of the candidate cell(s), and may send the RRC reconfiguration message to UE 901.

For example, the L1 condition for cell switching associated with a candidate cell could be one of the following:
(1) The channel quality of the candidate cell becomes offset better than the channel quality of the serving cell.
(2) The channel quality of the candidate cell is better than a configured threshold #1, and the channel quality of the serving cell is less than a configured threshold #2. The channel quality may be calculated in a physical layer.

In operation 915, CU 904 may transmit the RRC reconfiguration message associated with the candidate cell(s) for LTM configuration to UE 901 via source DU 902. For instance, the RRC reconfiguration message includes the RRC configuration associated with candidate cell(s) and the condition for cell switching, e.g. L1 or L3 condition.

In some embodiments, a condition for starting a TA acquisition procedure is configured, e.g. in the RRC reconfiguration message, to UE 901. UE 901 may start the TA acquisition procedure to the candidate cell(s) in response to fulfillment of this condition. This condition may be generated by CU 904 in a scenario based on a CHO or CPAC RRC framework. This condition may be generated by source DU 902 in a scenario based on LTM RRC framework. This condition could be that the channel quality of the serving cell of UE 901 is less than a configured threshold.

In operation 916, when the condition for a TA acquisition procedure is fulfilled, UE 901 may be triggered to perform the TA acquisition procedure to the candidate cell(s).

In operation 917, after UE 901 gets (early) TA value(s), the condition for cell switching (e.g. L1 or L3 condition) may be fulfilled.

In operation 918, UE 901 may perform a cell switching procedure once the condition for cell switching is fulfilled, e.g. UE 901 switches from the source cell to the candidate cell of candidate DU 903.

FIG. 10 illustrates an additional exemplary flowchart of a cell switching procedure in accordance with some embodiments of the present application. Details described in all other embodiments of the present application are applicable for the embodiments shown in FIG. 10.

As shown in FIG. 10, BS 1005 is in CU-DU architecture, and includes CU 1004, source DU 1002, and candidate DU 1003. In the embodiments shown in FIG. 10, a cell switch or change of UE 1001 may refer to an Intra-DU case in which a source cell and a target cell in the same DU or refer to an Inter-DU case in which a source cell and a target cell are located at different DUs. For instance, the flowchart 1000 as shown in FIG. 10 only shows a cell change in an Inter-DU case for the exemplary purpose.

In the exemplary flowchart 1000 as shown in FIG. 10, in operation 1011, UE 1001 may access the serving BS (e.g. gNB) and send a measurement report to the serving BS, for example, BS 1005. The serving BS may include a CU (e.g. gNB-CU) and one or more DUs (e.g. gNB-DUs). A serving cell is associated with a CU and a DU. There is an F1 interface between the DU and the CU. For example, as shown in FIG. 10, BS 1005 includes CU 1004, source DU 1002, and candidate DU 1003. BS 1005 may include one or more other candidate DUs (not shown in FIG. 10).

In operation 1012, CU 1004 may determine to initiate L1/L2 based inter-cell mobility configuration and transmit a request message, e.g. a UE CONTEXT SETUP REQUEST message, to candidate DU(s) (e.g. candidate DU 1003) which are associated with candidate cell(s). For example, the request message may be named as “a request for cell switching” or “the request of LTM configuration” or the like, and may include ID information of candidate cell(s).

In operation 1013, if candidate DU 1003 decides to accept the request of LTM configuration, candidate DU 1003 may generate lower layer RRC configuration for the accepted one or more candidate cell(s) and send a response message to CU 1004 including the generated lower layer RRC configuration. The response message could be a UE CONTEXT SETUP RESPONSE message.

In operation 1014, CU 1004 may generate an RRC reconfiguration message based on the configuration for the accepted candidate cell(s) received from candidate DU 1003.

In operation 1014, there may be different embodiments in different scenarios. In some embodiments, in a scenario based on CHO or CPAC RRC framework, CU 1004 may generate and configures L3 condition for cell switching based on L3 measurement result framework. In this scenario, a CHO procedure or a CPAC procedure may be enhanced to support a TA acquisition procedure and an early DL synchronization procedure. Namely, a network can request UE 601 to perform a TA acquisition procedure and an early DL synchronization procedure to a candidate cell when configuration information regarding CHO or CPAC associated with the candidate cell is configured.

In some other embodiments, in a scenario based on LTM RRC framework, source DU 1002 may generate L1 condition for cell switching based on L1 measurement framework. For instance, similar to L3 measurement framework, the L1 measurement framework includes resource settings, reporting settings, and/or trigger states. The L1 condition for cell switching may be used to replace the explicit cell switching command for LTM. LTM framework, e.g. RRC modeling, can be reused.

In an embodiment, candidate DU 1003 may generate and transmit L1 condition for cell switching to CU 1004 via F1AP message. The L1 condition for cell switching can be requested by CU 1004. Then, CU 1004 may generate an RRC reconfiguration message containing both the L1 condition received from candidate DU 1003 and RRC configuration information of the candidate cell(s), and may send the RRC reconfiguration message to UE 1001.

For example, the L1 condition for cell switching associated with a candidate cell could be one of the following:
(1) The channel quality of the candidate cell becomes offset better than the channel quality of the serving cell.
(2) The channel quality of the candidate cell is better than a configured threshold #1, and the channel quality of the serving cell is less than a configured threshold #2. The channel quality may be calculated in a physical layer.

In operation 1015, CU 1004 may transmit the RRC reconfiguration message associated with the candidate cell(s) for LTM configuration to UE 1001 via source DU 1002. For instance, the RRC reconfiguration message includes the RRC configuration associated with candidate cell(s) and the condition for cell switching, e.g. L1 or L3 condition.

In operation 1016, UE 1001 may receive information, which triggers a TA acquisition procedure to a candidate cell within the candidate cell(s) (e.g. a candidate cell of candidate DU 1003), from source DU 1002. In some embodiments, the information could be DCI, a MAC CE or RRC signaling. If the information is DCI, it could be a PDCCH order.

In operation 1017, UE 1001 may transmit a signal (e.g. a sequence, for instance, a dedicated preamble or a SRS) for TA acquisition, e.g. to candidate DU 1003.

In operation 1018, after UE 1001 gets (early) TA value(s), the condition for cell switching may be fulfilled. UE 1001 may start a timer for cell switching, e.g. Timer #2.

In operation 1019, UE 1001 may perform a cell switching procedure without performing an RA procedure to a target cell. In some embodiments, when the condition for cell switching is fulfilled, there may be no UL grant (pre-)configured for UE 1001. Regarding how to know the timing for a target cell to transmit a PDCCH transmission to UE 1001, there may be following three options in different embodiments, i.e. Option A, Option B, and Option C.
(1) Option A: Assuming TTT is used, UE 1001 may report information, which indicates that the condition for cell switching is about to be fulfilled, to the serving cell. Then, the serving cell may indicate the information to the candidate cell.
(2) Option B: Assuming TTT is used as well, UE 1001 may report the information, which indicates that the condition for cell switching is about to be fulfilled, to the serving DU, e.g. source DU 1002. Then, source DU 1002 may indicate the information to CU 1004, and CU 1004 may transfer the information to the candidate DU, e.g. candidate DU 1003.
(3) Option C: When the condition for cell switching is fulfilled and if no UL grant is (pre-)configured for UE 1001, UE 1001 may transmit a UL signal which aims to inform the candidate cell (i.e. a target cell) of accessing.

In operation 1020, UE 1001 may monitor a PDCCH transmission. Once UE 1001 successfully monitors a PDCCH transmission, e.g. from candidate DU 1003, UE 1001 may stop the timer for cell switching, e.g. Timer #2.

FIG. 11 illustrates an additional exemplary flowchart of a cell switching procedure in accordance with some embodiments of the present application. The embodiments of FIG. 11 study a procedure between a CU and a DU for early TA triggered by RRC configuration. Details described in all other embodiments of the present application are applicable for the embodiments shown in FIG. 11.

As shown in FIG. 11, BS 1105 is in CU-DU architecture, and includes CU 1104, source DU 1102, and candidate DU 1103. In the embodiments shown in FIG. 11, a cell switch or change of UE 1101 may refer to an Intra-DU case in which a source cell and a target cell in the same DU or refer to an Inter-DU case in which a source cell and a target cell are located at different DUs. For instance, the flowchart 1100 as shown in FIG. 11 only shows a cell change in an Inter-DU case for the exemplary purpose.

In the exemplary flowchart 1100 as shown in FIG. 11, in operation 111, UE 1101 may access the serving BS (e.g. gNB) and send a measurement report to the serving BS, for example, BS 1105. The serving BS may include a CU (e.g. gNB-CU) and one or more DUs (e.g. gNB-DUs). A serving cell is associated with a CU and a DU. There is an F1 interface between the DU and the CU. For example, as shown in FIG. 11, BS 1105 includes CU 1104, source DU 1102, and candidate DU 1103. BS 1105 may include one or more other candidate DUs (not shown).

In operation 112, CU 1104 may determine to initiate inter-cell L1/L2 based triggered mobility (LTM) configuration and transmit a request message, e.g. a UE CONTEXT SETUP REQUEST message to one or more candidate DUs (e.g. candidate DU 1103) which are associated with one or more candidate cells. For example, the request message may be named as “a request for cell switching” or “the request of LTM configuration” or the like, and may include ID information of candidate cell(s).

In operation 113, if candidate DU 1103 decides to accept the request of LTM configuration, candidate DU 1103 may generate lower layer RRC configuration for the accepted one or more candidate cell(s) and send a response message to CU 1104 including the generated lower layer RRC configuration. The response message could be a UE CONTEXT SETUP RESPONSE message.

In operation 114, CU 1104 may transmit an early TA request to candidate DU 1103. An early TA request may also be named as “a request for an early TA value”, “a request for a TA value”, or the like.

In operation 115, candidate DU 1103 may generate configuration information for a TA acquisition procedure for UE 1101 and transmit such configuration information to CU 1104. In some embodiments, such configuration information may include at least one of the followings:
(1) A candidate cell list to get (early) TA value(s). A (early) TA value for each candidate cell within the candidate cell list needs to be gotten by UE 1101.
(2) Dedicated RACH resource(s). The dedicated RACH resource(s) may be configured by candidate DU 1103, and may be used to implicitly indicate that a TA acquisition procedure is needed.
(3) An indication to perform a TA acquisition procedure. The indication may be configured by candidate DU 1103, and may be included in the RRC configuration associated with candidate cell(s) which is contained in an RRC reconfiguration message in operation 116.

In operation 116, CU 1104 may generate the RRC reconfiguration message associated with candidate cell(s) for LTM configuration based on the configuration information received from candidate DU 1103.

In operation 117, CU 1104 may transmit the RRC reconfiguration message to UE 1101 via source DU 1102. For instance, the RRC reconfiguration message includes the RRC configuration associated with candidate cell(s) and the configuration information for the TA acquisition procedure.

In operation 118, UE 1101 may perform a TA acquisition procedure for some candidate cells as indicated in the RRC configuration associated with candidate cell(s). For instance, based on the configuration information for the TA acquisition procedure, UE 1101 may start the TA acquisition procedure in response to reception of at least one the following:
(1) a Candidate Cell List;
(2) Dedicated Rach Resource(s) for Ta Acquisition; and
(3) an indication to perform the TA acquisition procedure.

In some embodiments of the present application, a UE or a network node as shown and illustrated in any of FIGS. 1-11 may have the following specific behaviors.

Behaviors of a UE (e.g. UE 102, the UE, UE 701, UE 801, UE 901, UE 1001, or UE 1101 as shown and illustrated in any of FIGS. 1, 3, and 7-11):

In some embodiments, a UE may perform a (early) TA acquisition procedure towards a candidate cell based on a PDCCH order which orders the (early) TA acquisition procedure or a corresponding indication in an RRC reconfiguration message.

In an embodiment, if the UE has obtained (early) TA value(s) of a candidate cell via an RA-based TA acquisition procedure (i.e. a RACH-based TA acquisition procedure) in an RAR (Msg2) message and the UE receives a LTM command for cell switching (i.e. a cell switching command for LTM) to the candidate cell (now a target cell) including a RACH request with or without dedicated PRACH resource(s), the UE may not perform an RA procedure to the target cell and may use the available (early) TA value(s) to adjust UL transmission time to announce its arrival on the target cell. For instance, the UE may transmit a MAC CE for Arrival Announcement if configured grant (CG) PUSCH resource(s) for transmitting the MAC CE for Arrival Announcement were configured for the target cell (i.e. the candidate cell in the RRC reconfiguration message).

In another embodiment, if the UE has obtained (early) TA value(s) of a candidate cell via an RA-based TA acquisition procedure in a MAC RAR (Msg2) message and the UE receives a LTM command for cell switching to the candidate cell (now a target cell) including a RACH request with or without dedicated PRACH resource(s), the UE may discard the (early) TA value(s) and perform an RA procedure afresh. TA value(s) and the Msg3 grant received in an RAR message may be used to announce its arrival on the target cell. For instance, the UE may transmit a MAC CE for Arrival Announcement.

In one example, the LTM command is a MAC CE which includes a flag indicating whether the UE shall perform an RA procedure on the target cell in order to acquire timing alignment. In a further example, the LTM command is a MAC CE which includes a field indicating RACH resource information which the UE shall use when performing an RA procedure on the target cell. For instance, the RACH resource information could be a preamble index or a time-frequency domain resource.

In an embodiment, when the UE receives a cell switching command including an indication indicating to perform an RA-based cell switching procedure, the UE may perform an RA-based cell switching procedure. If the RACH resource information is included in the cell switching command, the UE may perform an RA procedure using the indicted RACH resource information.

Alternatively, in a further embodiment, when the UE receives a cell switching command including an indication indicating to perform an RA-based cell switching procedure, the UE may ignore the indication if the UE has TA value(s) already. Namely, the UE can access the candidate cell without performing an RA procedure to the candidate cell (i.e. a target cell).

In another embodiment, when the UE receives a cell switching command without the indication indicating to perform an RA-based cell switching procedure, the UE will perform cell switching without performing an RA procedure to a target cell, i.e. an arrival message is sent only if the UE reported “TA acquisition information” to a source cell before receiving the cell switching command. If the UE didn't report “TA acquisition information” to the source cell before receiving the cell switching command, the UE will perform an RA-based handover (HO) procedure.

Alternatively, in an additional embodiment, a serving BS (e.g. gNB) can indicate explicitly whether a dynamic PUSCH grant can be expected from the target cell, and such indication may be included in the LTM command when a RACH request with or without dedicated PRACH resource(s) is included as well. If the UE has previously obtained (early) TA value(s) via an RA-based TA acquisition procedure in a MAC RAR (Msg2) message, upon receiving the LTM command, the UE may not perform an RA procedure and use the available (early) TA value(s) to announce its arrival on the target cell. For instance, the UE may transmit a MAC CE for Arrival Announcement if CG PUSCH resource(s) for transmitting the MAC CE for Arrival Announcement were configured for the target cell (i.e. the candidate cell in the RRC reconfiguration message). To this end, the UE may attempt to receive a dynamic PUSCH grant from the target cell using the UE's specific PDCCH configuration received in the RRC reconfiguration message for the corresponding candidate cell (which is not the target cell).

In an embodiment, if the UE has obtained (early) TA value(s) via an RA-based TA acquisition procedure, e.g. in a MAC RAR (Msg2) message, and the UE had not reported to the source cell that it had acquired (early) TA value(s) for the target cell and the UE receives a LTM command for cell switching to the candidate cell (now a target cell), the UE may perform an RA procedure afresh and discard the acquired (early) TA value(s).

In a further embodiment, if the UE has obtained (early) TA value(s) via an RA-based TA acquisition procedure, e.g. in a MAC RAR (Msg2) message, and the UE had already reported to the source cell that it had acquired (early) TA value(s) for the target cell and the UE receives a LTM command for cell switching to the candidate cell (now a target cell), the UE may use the available (early) TA value(s) to adjust UL transmission time to announce its arrival on the target cell. For instance, the UE may transmit a MAC CE for Arrival Announcement if CG PUSCH resource(s) for transmitting the MAC CE for Arrival Announcement were configured for the target cell (i.e. the candidate cell in the RRC reconfiguration message).

In all the above embodiments regarding the behaviors of the UE, in the cases where the RA procedure to obtain early TA value(s) is still ongoing, i.e. a MAC RAR message or Msg2 is not received yet when the UE receives a LTM command, the UE may keep Msg1 transmissions and waits for a MAC RAR message or Msg2 to arrive before applying the solutions of the above embodiments.

Behaviors of a network node (e.g. DU1, DU2, the source DU, source DU 702, source DU 802, source DU 902, source DU 1002, or source DU 1102 as shown and illustrated in any of FIGS. 2, 5, and 7-11):

In some embodiments, upon a source (serving) cell or a source DU arriving at a mobility decision, the source cell or the source DU may include a RACH request in a LTM command for mobility to a given target cell. The RACH request is included with or without dedicated PRACH resource(s) depending on whether dedicated PRACH resource(s) were reserved by the target cell or not. In addition, while sending the LTM command to the UE, the source cell or the source DU can inform a target cell or a target DU to start sending a DL PDCCH transmission with PUSCH grant(s) to the UE in question. If handshaking to start sending the DL PDCCH transmission with PUSCH grant(s) to the UE in question is successful, the source cell or the source DU can indicate explicitly in the LTM command whether a dynamic PUSCH grant can be expected from the target cell (or not).

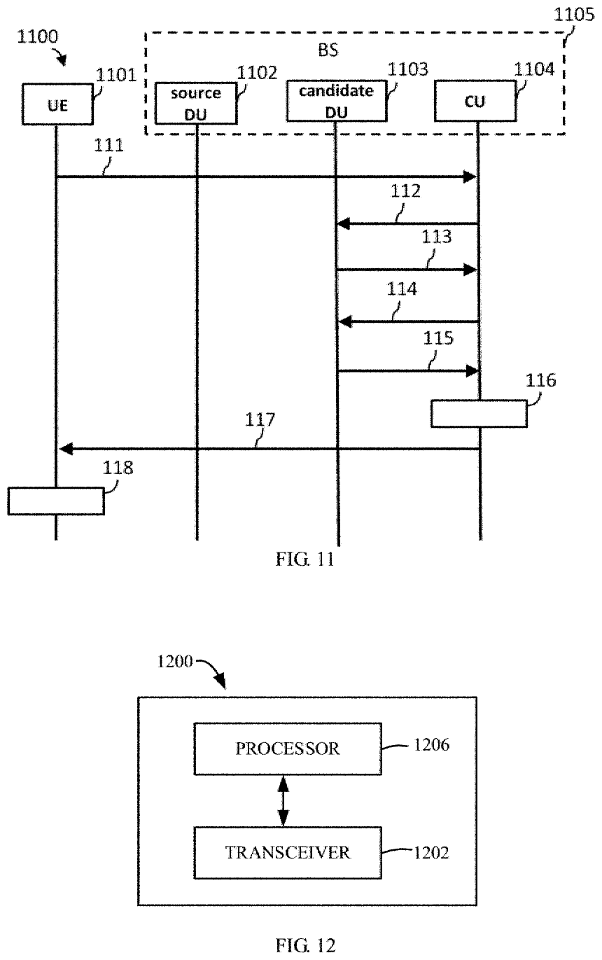

FIG. 12 illustrates a block diagram of an exemplary apparatus 1200 in accordance with some embodiments of the present application. As shown in FIG. 12, the apparatus 1200 may include at least one processor 1206 and at least one transceiver 1202 coupled to the processor 1206. Although in this figure, elements such as the at least one transceiver 1202 and processor 1206 are described in the singular, the plural is contemplated unless a limitation to the singular is explicitly stated. In some embodiments of the subject application, the transceiver 1202 may be divided into two devices, such as a receiving circuitry and a transmitting circuitry. In some embodiments of the subject application, the apparatus 1200 may further include an input device, a memory, and/or other components.

In some embodiments of the subject application, the apparatus 1200 may be a UE or a network node (e.g. a BS, a CU, or a DU). The transceiver 1202 and the processor 1206 may interact with each other so as to perform the operations with respect to the UE or the network node described above, for example, in any of FIGS. 1-11.

In some embodiments of the subject application, the apparatus 1200 may further include at least one non-transitory computer-readable medium. For example, in some embodiments of the present disclosure, the non-transitory computer-readable medium may have stored thereon computer-executable instructions to cause the processor 1206 to implement the method with respect to a UE or a network node (e.g. a BS, a CU, or a DU) as described above. For example, the computer-executable instructions, when executed, cause the processor 1206 interacting with transceiver 1202 to perform the operations with respect to the UE or the network node described in FIGS. 1-11.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A user equipment (UE) for wireless communication, comprising:
at least one memory; and
at least one processor coupled with the at least one memory and configured to cause the UE to:
receive, from a source cell, radio resource control (RRC) configuration information associated with one or more candidate cells; and
transmit an RRC configuration complete message in response to accessing one candidate cell within the one or more candidate cells based on the RRC configuration information.

2. The UE of claim 1, wherein the at least one processor is configured to cause the UE to receive, from the source cell, a set of execution conditions associated with the one or more candidate cells, and wherein the set of execution conditions is generated by a centralized unit (CU) of a base station (BS) or by a source distributed unit (DU) of the BS associated with the source cell.

3. The UE of claim 1, wherein the at least one processor is configured to cause the UE to receive configuration information associated with at least one of a first timer or a second timer, wherein the first timer is configured to be used when a timing advance (TA) value associated with the one or more candidate cells is unavailable at the UE, and wherein the second timer is configured to be used when the TA value is available at the UE.

4. The UE of claim 3, wherein the at least one processor is configured to cause the UE to evaluate an execution condition within a set of execution conditions based on reception of the RRC configuration information.

5. The UE of claim 4, wherein, in response to fulfillment of a first execution condition within the set of execution conditions associated with a first candidate cell within the one or more candidate cells when the UE is performing a random access (RA) procedure for timing advance (TA) acquisition for the first candidate cell, the at least one processor is configured to cause the UE to continue the RA procedure for TA acquisition for the first candidate cell.

6. The UE of claim 5, wherein the at least one processor is configured to cause the UE to at least one of:
apply a first RRC configuration within the RRC configuration information associated with the first candidate cell;
detach the source cell; or
start a timer for lower layer triggered mobility (LTM).

7. The UE of claim 6, wherein a length of the timer for LTM is equal to:
the length of the first timer; or
the length of the first timer minus elapsed time since starting the RA procedure for TA acquisition.

8. The UE of claim 5, wherein the at least one processor is configured to cause the UE to:
in response to a successful completion of the RA procedure for TA acquisition for the first candidate cell, apply a first RRC configuration within the RRC configuration information associated with the first candidate cell.

9. The UE of claim 1, wherein the at least one processor is configured to cause the UE to start a timing advance (TA) acquisition procedure in response to reception of at least one of:
a candidate cell list, wherein a TA value for each candidate cell within the candidate cell list is obtained by the UE;
a dedicated random access channel (RACH) resource for TA acquisition; and
an indication to perform the TA acquisition procedure.

10. The UE of claim 1, wherein the at least one processor is configured to cause the UE to perform a compliance check operation for a reference configuration associated with a second candidate cell within the one or more candidate cells.

11. The UE of claim 10, wherein the compliance check operation on the reference configuration is performed:
in response to reception of the reference configuration; or
if the UE performs a timing advance (TA) acquisition procedure; or
if the UE performs a cell switching procedure.

12. A centralized unit (CU) of a base station (BS) for wireless communication, comprising:
at least one memory; and
at least one processor coupled with the at least one memory and configured to cause the CU to:
receive radio resource control (RRC) configuration information associated with one or more candidate cells from one or more candidate distributed units (DU)s of the BS;
transmit the RRC configuration information to a user equipment (UE); and
receive an RRC configuration complete message from the UE via a source DU of the BS.

13. The CU of claim 12, wherein the at least one processor is configured to cause the CU to transmit, to the UE, a set of execution conditions associated with the one or more candidate cells, and wherein the set of execution conditions is generated by the CU or the source DU.

14. A source distributed unit (DU) of a base station (BS), comprising:
at least one memory; and
a at least one processor coupled with the at least one memory and configured to cause the source DU to:
receive, from a centralized unit (CU) of the BS, radio resource control (RRC) configuration information associated with one or more candidate cells; and
transmit, to a user equipment (UE), the RRC configuration information.

15. The source DU of claim 14, wherein the at least one processor is configured to cause the source DU to transmit, to the UE, a set of execution conditions associated with the one or more candidate cells, and wherein the set of execution conditions is generated by the CU and received by the source DU from the CU, or the set of execution conditions is generated by the source DU of the BS.

16. A method performed by a user equipment (UE), the method comprising:
receiving, from a source cell, radio resource control (RRC) configuration information associated with one or more candidate cells; and
transmitting an RRC configuration complete message in response to accessing one candidate cell within the one or more candidate cells based on the RRC configuration information.

17. The method of claim 16, further comprising:
receiving, from the source cell, a set of execution conditions associated with the one or more candidate cells, and wherein the set of execution conditions is generated by a centralized unit (CU) of a base station (BS) or by a source distributed unit (DU) of the BS associated with the source cell.

18. The method of claim 16, further comprising:
receiving configuration information associated with at least one of a first timer or a second timer, wherein the first timer is configured to be used when a timing advance (TA) value associated with the one or more candidate cells is unavailable at the UE, and wherein the second timer is configured to be used when the TA value is available at the UE.

19. The method of claim 18, further comprising:
evaluating an execution condition within a set of execution conditions based on reception of the RRC configuration information.

20. The method of claim 19, further comprising:
continuing a random access (RA) procedure for timing advance (TA) acquisition for the first candidate cell in response to fulfillment of a first execution condition within the set of execution conditions associated with a first candidate cell within the one or more candidate cells when the UE is performing the RA procedure for the TA acquisition for the first candidate cell.
